(19) United States
(12) Patent Application Publication
(10) Pub. No.: US 2007/0038713 A1
(43) Pub. Date: Feb. 15, 2007

(54) Mail processing apparatus, mail processing system, and mail processing method

(75) Inventor: Mitsuo Ryu, Ayase-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/222,827

(22) Filed: Sep. 12, 2005

(30) Foreign Application Priority Data
Jul. 29, 2005 (JP) 2005-221720

(51) Int. Cl. G06F 15/16

(52) U.S. Cl. 709/206

(57) ABSTRACT

A redirect mail processing machine processes mail judged to be a redirect mail by a mail sorting machine. The redirect mail processing machine has a takeout unit which supplies a redirect mail to a transfer path, an ID code reader which reads an ID code from a redirect mail, a labeler which sticks a label to a redirect mail, a changed address information printer which prints changed address information on a redirect mail, and an in-office bar code printer which prints an in-office bar code corresponding to changed address information.

### CROSS-REFERENCE TO RELATED APPLICATIONS

This application is based upon and claims the benefit of priority from prior Japanese Patent Application No. 2005-221720, filed Jul. 29, 2005, the entire contents of which are incorporated herein by reference.

### BACKGROUND OF THE INVENTION

1. Field of the Invention

The present invention relates to a mail processing apparatus, mail processing system and mail processing method, which read address information from mail and sort the mail.

2. Description of the Related Art

There is a conventional mail processing apparatus, which refers to an address information table prepared previously for the address information read from mail, and if the read address information includes a changed address, sorts it to a box corresponding to the changed address. (Refer to Jpn. Pat. Appln. KOKAI Publication No. 2002-346482.) This apparatus prevents delivery of mail with a changed new address to an old address before the change, and eliminates the labor of re-delivery.

However, the above apparatus merely sorts mail with changed address information to a box corresponding to the changed address. A post office to delivery the mail needs to find out the changed address based on the address before the change written on the mail, and to re-write the address by hand. Thus, much time and labor are required to process a redirect mail.

### BRIEF SUMMARY OF THE INVENTION

It is an object of the present invention to provide a mail processing apparatus, mail processing system, and mail processing method, which can efficiently process redirect mail having information of address before change.

The present invention has been made in order to achieve the above object. According to a first aspect of the present invention, there is provided a mail processing apparatus comprising a supply unit which supplies a redirect mail written with information of address before change and given an ID code, a memory unit which stores information about a changed address of the redirect mail related to the ID code, an ID code reader which reads an ID code from the redirect mail supplied from the supply unit, a control unit which searches the memory unit based on the read ID code and obtains changed address information of the redirect mail, and a changed address information printer which prints the changed address information obtained by the control unit on the redirect mail.

According to a second aspect of the present invention, there is provided a mail processing system comprising a mail sorting machine which reads address information of mail and sorts and stacks the mail based on the read address information, and when the read address information is judged to be the address information before change, gives an ID code to the redirect mail, obtains changed address information from database, stores the information related to the ID code, and sorts and stacks the redirect main in a specified place; and a redirect mail processing machine which inputs and processes the redirect mail sorted and stacked in the specified place; wherein the redirect main processing machine has a supply unit which supplies an input redirect mail, a memory unit which downloads and stores an ID code and changed address information stored relating to each other in the mail sorting machine, an ID code reader which reads an ID code from the redirect mail supplied from the supply unit, a control unit which searches the memory unit based on the read ID code and obtains a changed address information of the redirect mail, and a changed address information printer which prints a changed address information obtained by the control unit on the redirect mail.

According to a third aspect of the present invention, there is provided a mail processing method comprising a step of supplying a redirect mail written with address information before change and given an ID code, a step of reading an ID code from a redirect mail supplied in the mail supplying step, a step of obtaining changed address information of the redirect mail from a memory unit which stores information about the changed address of the redirect mail related to the ID code by using the ID code read in the ID code reading step as a key, and a step of printing changed address information obtained in the changed address information obtaining step on the redirect mail.

According to the present invention, a mail judged to be a redirect mail by a mail sorting machine is inputted to a redirect mail processing machine, changed address information stored related to an ID code given to each redirect mail by a mail sorting machine is downloaded to a redirect mail processing machine, the ID code is read from a redirect mail supplied by a redirect mail processing machine, and the changed address information searched based on the ID code is printed on a corresponding redirect mail. Therefore, a redirect mail is not redelivered to an address before change, eliminating the labor of redelivery, and a redirect mail written with an address before change can be efficiently processed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the schematic construction of a mail sorting machine built in a mail processing system according to an embodiment of the present invention;

FIG. 2 is a block diagram showing the schematic construction of a redirect mail processing machine built in a mail processing system according to an embodiment of the present invention;

FIG. 3A and FIG. 3B show flowcharts for explaining the operation of the mail processing system of FIG. 1 and FIG. 2;

FIG. 4 is a view showing the positions of ID code and in-office bar code printed on mail; and

FIG. 5 is a view showing a label L stuck at a position to cover over the ID code and in-office bar code of FIG. 4.

### DETAILED DESCRIPTION OF THE INVENTION

Embodiments of the present invention will be explained in detail hereinafter with reference to the accompanying drawings.

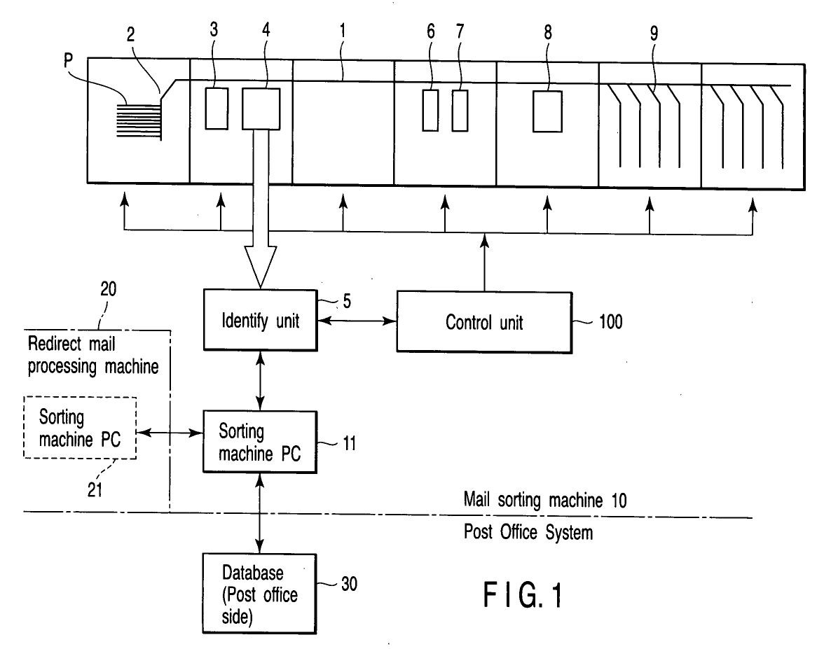

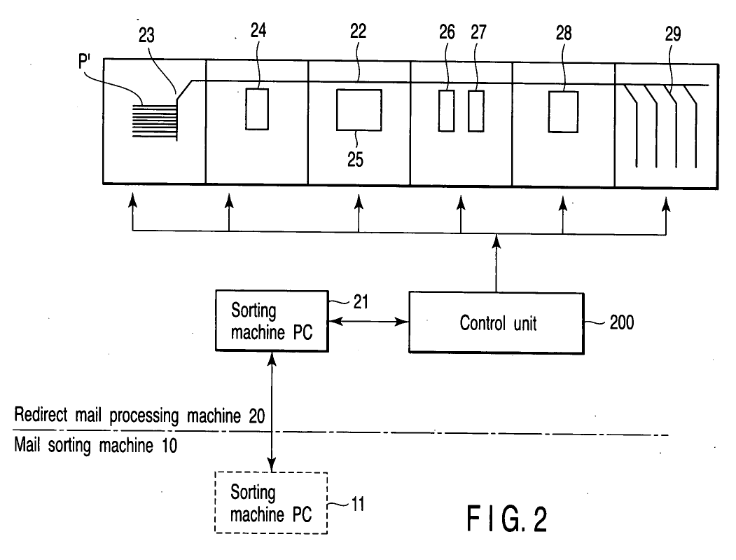

FIG. 1 shows a block diagram of the schematic construction of a mail sorting machine 10 built in a mail processing system (hereinafter referred to as a system) according to an embodiment of the present invention. FIG. 2 shows a block diagram of the schematic construction of a redirect mail processing machine 20 built in the system, which serves as a mail processing apparatus. As shown in FIG. 1 and FIG. 2, the mail sorting machine 10 and redirect mail processing machine 20 are connected through two sorting machines PC11 and 21.

The redirect mail processing machine 20 processes mail judged to be a redirect mail as a result of the processing in the mail sorting machine 10. A redirect mail indicates mail forwarded to a receiver whose address has been changed from the address written on the mail. Such a redirect mail occurs when a sender of the mail does not know that the address of a receiver has been changed.

As shown in FIG. 1, the mail sorting machine 10 has a takeout unit 2 to take out mail P one by one onto a transfer path 1, a not-shown rejection unit to reject nonstandard-size mail or mail containing foreign matter out of the mail P taken out onto the transfer path 1, a pre-barcode reader 3 (bar code reader) to check whether an in-office bar code is given to the mail P taken out onto the transfer path 1, a scanner 4 to read an image including address information including a zip code, address and name, an identify unit 5 to identifies the address information from the image read with the scanner 4, an ID code printer 6 to print an ID code to the mail P when the identified address information is old address information before change, an in-office bar code printer 7 to print an in-office bar code corresponding to the identified address information, a verify reader 8 to read the printed in-office bar code for verification, a sorting/stacking unit to sort and stack the mail P according to the identification result in the identify unit 5, and a control unit 100 to control the operations of the above units.

The sorting machine PC 11 connected to the identify unit 5 is connected with the sorting machine PC 21 of the redirect mail processing machine 20 and a database 30 of a post office system. The database 30 stores all address information together with the corresponding in-office bar codes, and contains address information including changed new addresses and zip codes related to old address information before the change if they have been notified to a post office. The information stored in the database 30 is updated whenever a change of address is notified, and downloaded to the sorting machine PC 11 of the mail sorting machine 10 whenever needed, and downloaded further from the sorting machine PC 11 to the sorting machine PC 21 of the redirect mail processing machine 20 if necessary.

As shown in FIG. 2, the redirect mail processing machine 20 has a takeout unit 23 (supply unit) to take out mail processed by the mail sorting machine 10, that is, redirect mail P′ one by one onto a transfer path 22, a not-shown rejection unit to reject a redirect mail P′ taken out in bad position out of the redirect mail P′ taken out onto the transfer path 22, an ID code reader 24 to read an ID code printed on the redirect mail P′, a labeler 25 (label sticker) to stick a label L (refer to FIG. 5) on an in-office bar code given to the redirect mail P′, a changed address information printer 26 to print changed address information including new address and zip code on the label L on of the redirect mail P′, an in-office bar code printer 27 (code information printer) to print an in-office bar code corresponding to a new address on the label L, a verify reader 28 to read the printed in-office bar code for verification, a sorting/stacking unit 29 to sort and stack the processed redirect mail P′, and a control unit 200 to control the operations of the above units.

The labeler 25 has a not-shown cylindrical labeling head which rotates in contacting with the redirect mail P′ transferred through the transfer path 22, and wind a slender tape member with many labels L set thereon around the head. The label sticking position is set to a position to cover over the in-office bar code, when an in-office bar code has been given already to the redirect mail P′. Namely, the in-office bar code given to the redirect mail P′ corresponds to the address information before change, and unnecessary for processing the redirect mail P′. It is rather desirable not to identify the in-office bar code to prevent mis-identification. The labeling position can be changed by moving the not-shown head of the labeler 25. For example, the label L may be stuck at a position where address information before change is written.

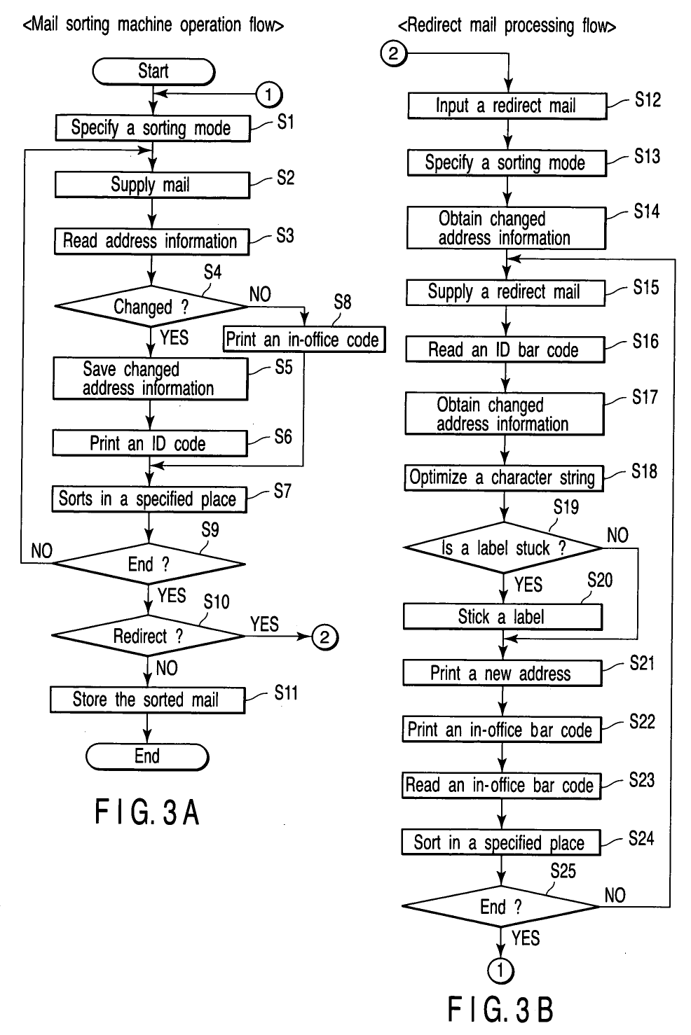

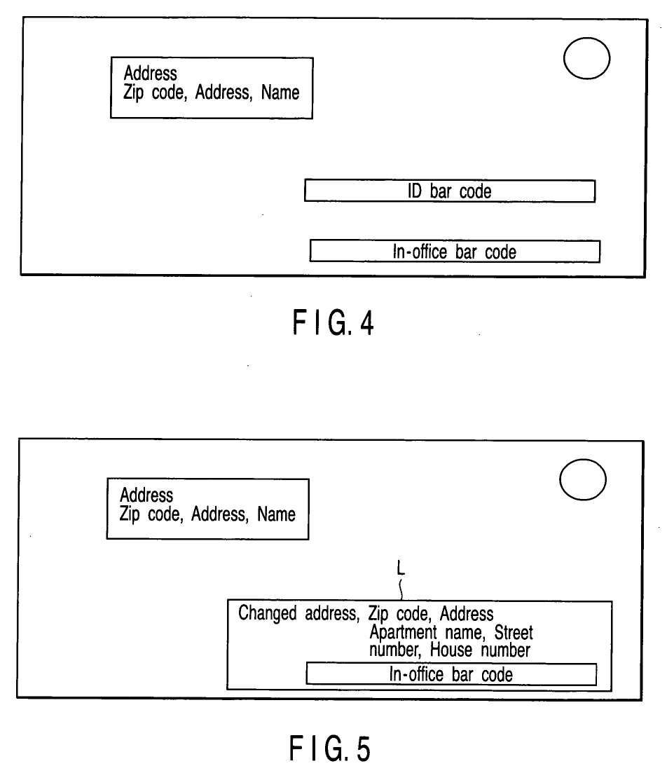

Now explanation will be given on the processing of mail P with the mail processing system having the above-mentioned structure with reference to the flowcharts of FIGS. 3A/3B, FIG. 4 and FIG. 5. The flowchart of FIG. 3A shows the flow of processing with the mail sorting machine 10. The flowchart of FIG. 3B shows the flow of processing with the redirect mail processing machine 20.

Before the processing, an operator specifies a sorting mode through a not-shown operation panel of the mail sorting machine 10 (FIG. 3A, step 1), and manually inputs mail P to the mail sorting machine 10. In this time, it is assumed that the sorting machine PC 11 of the mail sorting machine 10 has been downloaded with address information and changed address information from the database 30 at a predetermined timing.

First, the control unit 100 of the mail sorting machine 10 controls the takeout unit 2, takes out mail P one by one onto the transfer path 1, and starts supplying the mail P (step 2). The taken-out mail P is transferred at certain intervals on the transfer path 1, and nonstandard-size mail and mail containing foreign matter are rejected with the not-shown rejection unit. The control unit 100 checks whether an in-office bar code is given to the mail P taken out onto the transfer path 1 through the pre-barcode reader, and reads an image containing the address information of mail P through the scanner 4. The image read with the scanner 4 is sent to the identify unit 5. The identify unit 5 refers to the information downloaded to the sorting machine PC 11 for the image sent from the scanner 4, and identifies the address information of the mail P (step 3).

When the address of the mail P is identified to have been changed and old as a result of the identification in step 3, (step 4, YES), that is, when the changed address information about the identified address information has been included in the downloaded information, the identify unit 5 judges the mail to be a redirect mail P′, gives an ID code to the changed address information about the old address, saves the information in the sorting machine PC 11 (step 5), and sends the ID code related to the changed address information to the control unit 100. In this time, whether an in-office bar code has been given to the redirect mail P′ related to the changed address information of the redirect mail P′ is stored. For example, a flag is raised in this time to indicate whether the in-office bar code is given or not. The control unit 100 controls the ID code printer 6, prints the ID code notified from the identify unit 5 on the redirect mail P′ transferred onto the transfer path 1 (step 6), and sorts and stacks the redirect mail P′ in a specified place of the sorting/stacking unit 9 (step 7).

Contrarily, if changed address information is not related to the address information of the mail P as a result of the identification in step 3, (step 4, NO), the identify unit 5 judges the mail P not a redirect mail P′, and notifies the control unit 100 of an in-office bar code corresponding to the address information of the mail P. The control unit prints the in-office bar code notified by the identify unit 5 on the mail P through the in-office bar code printer 7 (step 8), identifies the printed in-office bar code through the verify reader 8, and sorts and stacks the mail P in a specified place of the sorting/stacking unit 9 (step 7).

The control unit 100 repeats the operations of step 2 to step 8 until no mail P is taken out by the takeout unit 2 (step 9, YES), and sorts and stacks the mail P (or the redirect mail P′) in a specified sorting place. After the sorting operation is finished (step 9, YES), the redirect mail P′ sorted and stacked in the specified place is manually inputted to the redirect mail processing machine 20 by the operator (step 10, YES, FIG. 3B, step 12), and all mails P except the redirect mail P′ sorted and stacked in the specified place are manually stored in a specified storing place by the operator (step 10, NO, step 11).

When a redirect mail sorting mode is specified through the not-shown operation panel after the redirect mail P′ is inputted to the redirect mail processing machine 20 in step 12 (step 13), the control unit 200 of the redirect mail processing machine 20 controls the sorting machine PC 21 and downloads the changed address information saved in the sorting machine PC 11 of the mail sorting machine 10 in step 5 (step 14). In this time, the control unit 200 obtains also the information about the existence of an in-office bar code related to the changed address information, and saves the information in the sorting machine PC 21 (memory unit).

Thereafter, the control unit 200 controls the takeout unit 23, takes out the redirect mail P′ one by one onto the transfer path 22, starts supplying the redirect mail P′ (steps 15), and rejects a redirect mail P′ taken out in a bad position with the not-shown rejection unit. The control unit 200 reads the ID code printed on each redirect mail P′ in step 6 through the ID code reader 24 (step 16), and searches and reads the changed address information of the redirect mail downloaded in the sorting machine PC 21 by using the read ID code as a key (step 17).

Further, the control unit 200 optimizes character strings such as new zip codes and addresses contained in the changed address information obtained from the sorting machine PC 21 (step 18), and controls the labeler 25 if necessary to stick the label L to the corresponding redirect mail P′ (step 19, YES, step 20). In this time, the control unit 200 judges whether to stick the label L based on the information about the existence of an in-office bar code obtained related to the changed address information read from the sorting machine PC 21 in step 17 (step 19).

For example, as shown in FIG. 4, when an in-office bar code has already been given to the redirect mail P′ (step 19, YES), stick the label L to cover over the in-office bar code as shown in FIG. 5. In the embodiment of the invention, the label L is stuck to cover over also the ID code printed in the mail sorting machine 10. If an in-office bar code is not given to the redirect mail P′ (step 19, NO), the label L need not to be stuck to the redirect mail P′. However, if the redirect mail P′ is relatively dark or a letter put in a vinyl envelope, the label L may be stuck to the redirect mail P′.

The control unit 200 prints the changed address information on the redirect mail P′ through the changed address information printer 26 optimized in step 18 (step 21). In this time, if the label L has been stuck to the redirect mail P′ in step 20, the changed address information is printed on the label L as shown in FIG. 5. If the label L has not been stuck, the changed address information is directly printed on the surface of the redirect mail P′. The changed address information printer 26 has a 2-head inkjet printer, and prints the optimized changed address information in two lines of character string.

Then, the control unit 200 controls the in-office bar code printer 27, and prints the in-office bar code corresponding to the changed address information obtained in step 17 on the redirect mail P′ (step 22). In this time, if the label L has been stuck to the redirect mail P′ in step 20, the changed address information is printed on the label L as shown in FIG. 5. If the label L has not been stuck, the changed address information is directly printed on the redirect mail P′.

Further, the control unit 200 controls the verify reader 28, reads the in-office bar code printed in step 22, and checks whether the in-office bar code is normally printed or not (step 23). This operation of reading the in-office bar code for verification is unnecessary later when the redirect mail P′ processed by the redirect mail processing machine 20 is re-inputted to the mail sorting machine 10. Then, the control unit 200 controls the sorting/stacking unit 29, and sorts and stacks the redirect mail P′ whose in-office bar code has been verified (step 24).

The control unit 200 repeats the processing of step 15 to step 24 until all the redirect mail P′ inputted into the redirect mail processing machine 20 in step 12 are processed (step 25, YES). After all the redirect mail P′ are processed, the operator manually re-inputs the redirect mail P′ sorted and stacked in a specified place into the mail sorting machine 10. Thereafter, the mail sorting machine 10 reads the in-office bar code printed on each redirect mail P′ in step 22, and sorts the mail based on the changed address information.

As described above, in this embodiment, the mail judged to be a redirect mail P′ by the mail sorting machine 10 is inputted to the redirect mail processing machine 20, changed address information including zip codes and addresses is printed on all redirect mail P′ in the redirect mail processing machine 20, an in-office bar code corresponding to the changed address information is printed, and the redirect mail P′ processed in this way is re-inputted to the mail sorting machine 10. Thus, the redirect mail P′ can be handled in the same way as ordinary mail in the state printed with the changed address information and corresponding in-office bar code. This eliminates the labor of re-delivery of the redirect mail P′ after once delivered to an old address before change, and processes the redirect mail P′ efficiently.

Further, in this embodiment, if an in-office bar code has been printed on the redirect mail P′, the label L is stuck at a position to cover over the in-office bar code, and new address information and in-office bar bode are printed on the label L. This eliminates misidenfication of an in-office bar code corresponding to address information before change given to a redirect mail P′, and enhances the processing reliability. The label L may be stuck to a relatively dark mail or mail put in a vinyl envelope, to increase the ratio of identifying the address information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

For example, in the description of the above-mentioned embodiment, even the ID code given to the redirect mail P′ in the mail sorting machine 10 is hidden by the label L. However, at least only the in-office bar code may be hidden.

What is claimed is:

1. A mail processing apparatus comprising:
a supply unit which supplies a redirect mail written with information of address before change and given an ID code;
a memory unit which stores information about a changed address of the redirect mail related to the ID code;
an ID code reader which reads the ID code from the redirect mail supplied from the supply unit;
a control unit which searches the memory unit based on the read ID code and obtains changed address information of the redirect mail; and
a changed address information printer which prints the changed address information obtained by the control unit on the redirect mail.

2. The mail processing apparatus according to claim 1, further comprising a code information printer which prints the code information of the coded changed address information obtained by the control unit on the redirect mail.

3. The mail processing apparatus according to claim 1, further comprising a label sticker which sticks a label to a redirect mail to cover over unnecessary information, when the unnecessary information is written on the redirect mail supplied from the supply unit.

4. The mail processing apparatus according to claim 3, wherein information about the existence of the unnecessary information is related to the changed address information and stored in the memory.

5. The mail processing apparatus according to claim 3, wherein the changed address information printer prints the changed address information on the label stuck to the redirect mail in the label sticker.

6. The mail processing apparatus according to claim 3, further comprising a code information printer which prints the code information of the coded changed address information obtained in the control unit on the label stuck to the redirect mail in the label sticker.

7. A mail processing system comprising:
a mail sorting machine which reads address information of mail and sorts and stacks the mail based on the read address information, and when the read address information is judged to be address information before change, gives an ID code to this redirect mail, obtains changed address information from database, stores the information related to the ID code, and sorts and stacks the redirect mail in a specified place; and
a redirect mail processing machine which inputs and processes the redirect mail sorted and stacked in the specified place;
wherein the redirect mail processing machine has a supply unit which supplies an input redirect mail,
a memory unit which downloads and stores an ID code and changed address information stored related to each other in the mail sorting machine,
an ID code reader which reads an ID code from the redirect mail supplied from the supply unit,
a control unit which searches the memory unit based on the read ID code and obtains the changed address information of the redirect mail, and
a changed address information printer which prints the changed address information obtained by the control unit on the redirect mail.

8. The mail processing system according to claim 7, further comprising a code information printer which prints the code information of the coded changed address information obtained by the control unit on the redirect mail.

9. The mail processing system according to claim 7, further comprising a label sticker which sticks a label to a redirect mail to cover over unnecessary information, when the unnecessary information is written on the redirect mail supplied from the supply unit.

10. The mail processing system according to claim 9, wherein the mail sorting machine has a bar code reader for checking whether an in-office bar code has been given to mail, and stores changed address information of the redirect mail and information about whether the in-office bar code is given to the redirect mail or not, by relating to the ID code;
the memory of the redirect mail processing machine downloads the information stored related to the ID code from the mail sorting machine, and stores the information; and
the label sticker sticks a label to cover over an in-office bar code if the in-office bar code has been given to the redirect mail, based on the information about the existence of an in-office bar code related to the ID code of the redirect mail and stored in the memory.

11. The mail processing system according to claim 10, wherein the label sticker sticks a label at a position to cover over the ID code and in-office bar code.

12. The mail processing system according to claim 9, wherein the changed address information printer prints the changed address information on the label stuck to the redirect mail in the label sticker.

13. The mail processing system according to claim 9, further comprising a code information printer which prints the code information of coded changed address information obtained by the control unit on the label stuck to the redirect mail in the label sticker.

14. A mail processing method comprising:
a step of supplying a redirect mail written with address information before change and given an ID code;
a step of reading an ID code from a redirect mail supplied in the mail supplying step;
a step of obtaining changed address information of the redirect mail from a memory unit which stores information about the changed address of the redirect mail related to the ID code by using the ID code read in the ID code reading step as a key; and
a step of printing changed address information obtained in the changed address information obtaining step on the redirect mail.

15. The mail processing method according to claim 14, further comprising a step of sticking a label to a redirect mail to cover over unnecessary information, when the unnecessary information is written on the redirect mail supplied in the mail supplying step.

16. The mail processing method according to claim 15, wherein the step of printing the changed address information prints the changed address information on the label stuck to the redirect mail in the step of sticking a label.
